(19) United States
(12) Patent Application Publication
(10) Pub. No.: US 2015/0054380 A1
(43) Pub. Date: Feb. 26, 2015

(54) ROTATING ELECTRIC MACHINE

(71) Applicant: HONDA MOTOR CO., LTD., Tokyo (JP)

(72) Inventor: Takanori Suzuki, Utsunomiya-shi (JP)

(73) Assignee: HONDA MOTOR CO., LTD., Tokyo (JP)

(21) Appl. No.: 14/356,226

(22) PCT Filed: Oct. 16, 2012
(86) PCT No.: PCT/JP2012/076721

§ 371 Date: May 5, 2014

(30) Foreign Application Priority Data
Nov. 21, 2011 (JP) 2011-253620

(51) Int. Cl. H02K 1/06

(52) U.S. Cl. CPC H02K 1/06
USPC 310/216.106

(57) ABSTRACT

A rotating electric machine that is equipped with a stator that has teeth which are formed between adjoining slots and coils which are wound around the teeth, and a rotor that has magnetic pole sections at multiple aperture sections which are arranged in the circumferential direction, wherein magnetic flux saturation facilitating sections such as grooves for further facilitating magnetic flux saturation in magnetic flux saturation regions are provided at least on the stator or on the rotor at positions close to the magnetic flux saturation regions of the stator or the rotor in order to reduce torque ripples of the rotating electric machine.

### TECHNICAL FIELD

The present invention relates to a rotary (rotating) electric machine (an electric motor or a generator-motor) having a rotatable element (hereinafter referred to as “rotor”) and a fixed element (hereinafter referred to as “stator”), and more particularly to a rotary electric machine suitable for use on a vehicle (also referred to as “electrically propelled vehicle”) such as an electric vehicle (EV), a hybrid vehicle (HEV), a plug-in hybrid vehicle (PHEV), a fuel cell vehicle (FCV), or the like.

### BACKGROUND ART

Rotary electric machines for use on electrically propelled vehicles have, for example, a rotor having an IPM (Interior Permanent Magnet) structure with permanent magnets housed in a rotor core and a stator having a stator core that serves as a magnetic circuit and coils wound around teeth of the stator core for generating a rotating magnetic field.

On rotary electric machines of the above structure, a change in the output torque depending on the rotational angle of the rotor is referred to as a torque ripple, which should desirably be small as it accounts for rotation irregularities, vibration, and noise.

Torque ripples include a cogging torque ripple (hereinafter referred to as “cogging ripple”) that occurs even when the rotary electric machine is not energized and a current torque ripple that occurs in the torque with which the rotor rotates when the rotary electric machine is energized. While the rotor of the rotary electric machine is in rotation, the rotary electric machine suffers a combined torque ripple that is a combination of the cogging ripple and the current torque ripple (the combined torque ripple will be referred to simply as “torque ripple”).

Japanese Laid-Open Patent Publication No. 2009-189163 (hereinafter referred to as “JP2009-189163A”) discloses a technology for reducing cogging ripples (see [0008] of JP2009-189163A).

### SUMMARY OF INVENTION

Electrically propelled vehicles which incorporate a rotary electric machine of the type described above need to reduce torque ripples generated by the rotary electric machine because the torque ripples are responsible for noise and vibration such as noise which is produced when the electrically propelled vehicles travel normally and vibration which is produced when the electrically propelled vehicles creep.

The technology disclosed in JP2009-189163A is capable of reducing cogging ripples at the cost of increased torque ripples. Therefore, it is not adequate to apply the technology disclosed in JP2009-189163A to rotary electric machines for use on electrically propelled vehicles.

Actually, the magnitude (amplitude) of a torque ripple is more than roughly several times the magnitude (amplitude) of a cogging ripple, and it has been found that it is important to reduce torque ripples for the purpose of reducing noise and vibration on electrically propelled vehicles.

The present invention has been made in view of the above problems. It is an object of the present invention to provide a rotary electric machine which is capable of reducing torque ripples.

According to the present invention, there is provided a rotary electric machine including a stator having S number of slots formed circumferentially therein, teeth each disposed between adjacent ones of the slots, and coils wound around the teeth, and a rotor disposed on tip ends of the teeth of the stator with an air gap left between the rotor and the tip ends and having P number of magnetic pole assemblies disposed respectively in openings defined in the rotor, the magnetic pole assemblies being circumferentially arranged and having permanent magnets, wherein at least one of the stator and the rotor has a magnetic flux saturation promoter for promoting the saturation of magnetic fluxes in a region, where magnetic flux saturation occurs in the stator and the rotor, the magnetic flux saturation promoter being positioned near the region where the magnetic flux saturation occurs, at a rotor phase position in which the torque of an nth harmonic component of a fundamental wave represented by a least common multiple M of the number S of the slots and the number P of rotor poles of the rotor is maximum.

According to the present invention, since the magnetic flux saturation promoter is positioned near the region (magnetic flux saturation region) where magnetic flux saturation occurs, at the rotor phase position in which the torque of the nth harmonic component of the fundamental wave represented by the least common multiple M is maximum, the magnetic resistance of the magnetic flux saturation region is increased, and consequently, it is possible to reduce the torque of the nth harmonic component of the fundamental wave represented by the least common multiple M.

In this case, the magnetic flux saturation promoter may include a groove or a hole defined in each of the tip ends of the teeth of the stator and extending in an axial direction of the stator.

The magnetic flux saturation promoter may alternatively include a groove or a hole defined in the rotor radially outwardly of each of the magnetic pole assemblies and extending in an axial direction of the rotor.

In this case, the magnetic flux saturation promoter may include the groove or the hole defined in each of the tip ends of the teeth of the stator and extending in the axial direction of the stator, and another groove or another hole defined in each of the tip ends of the teeth of the stator and extending in the axial direction of the stator, the groove or the hole and the other groove or the other hole being disposed symmetrically with respect to the circumferential center of each of the tip ends of the teeth. The symmetrical layout of the groove or the hole and the other groove or the other hole is effective to reduce torque ripples produced when the rotary electric machine operates in power and regenerative modes.

Alternatively, the magnetic flux saturation promoter may preferably include the groove or the hole defined in the rotor radially outwardly of each of the magnetic pole assemblies and extending in the axial direction of the rotor, and another groove or another hole defined in the rotor radially outwardly of each of the magnetic pole assemblies and extending in the axial direction of the rotor, the groove or the hole and the other groove or the other hole being disposed symmetrically with respect to the circumferential center of each of the magnetic pole assemblies in the rotor. The symmetrical layout of the groove or the hole and the other groove or the other hole is effective to reduce torque ripples produced when the rotary electric machine operates in power and regenerative modes. Since the grooves or the holes for promoting the saturation of magnetic fluxes are formed preferentially in the rotor radially outwardly of the magnetic pole assemblies, the rotor can be reduced in weight.

The magnetic flux saturation promoter may preferably include a first groove or a first hole defined in at least one of the rotor radially outwardly of each of the magnetic pole assemblies, and each of the tip ends of the teeth and extending in an axial direction of the rotary electric machine, and a second groove or a second hole defined in at least one of the stator and the rotor near a region where magnetic flux saturation occurs, at a rotor phase position in which the torque of an nth harmonic component produced due to the first groove or the first hole or an mth harmonic component different from the nth harmonic component is maximum.

Since the second groove is defined near the region where magnetic flux saturation occurs, at the rotor phase position in which the torque of the nth harmonic component produced due to the first groove or the mth harmonic component different from the nth harmonic component is maximum, it is possible to reduce the torque of the nth harmonic component produced due to the first groove or the mth harmonic component different from the nth harmonic component.

The first groove or the first hole may preferably be defined in the rotor radially outwardly of each of the magnetic pole assemblies, and the second groove or the second hole may be defined in at least one of the rotor radially outwardly of each of the magnetic pole assemblies, and each of the tip ends of the teeth. The grooves for promoting the saturation of magnetic fluxes are thus defined preferentially in the rotor, whereby the weight of the rotor can be reduced.

According to the present invention, the order of a harmonic component that provides cause of a torque ripple is identified, and a magnetic flux saturation region Q is identified. The magnetic resistance of the identified magnetic flux saturation region is further increased. Consequently, the maximum torque of the harmonic of the order that produces the torque ripple can thus be reduced. According to the present invention, therefore, torque ripples can be reduced efficiently with a simple structure.

### BRIEF DESCRIPTION OF DRAWINGS

FIG. 1 is a cross-sectional view of a rotary electric machine according to an embodiment of the present invention;

FIG. 2A is a view showing the direction of a torque produced on a rotor;

FIG. 2B is a view showing the direction of a torque produced on a stator;

FIG. 2C is an enlarged fragmentary view of the stator shown in FIG. 2B;

FIG. 3 is a diagram showing a sequence of determining positions in which to form grooves for reducing torque ripples;

FIG. 4 is a graph showing a torque waveform and an nth harmonic torque waveform having a maximum amplitude which is obtained from the torque waveform by way of an FFT analysis;

FIG. 5 is a view showing a magnetic flux distribution at a position where the rotor has rotated through a predetermined rotational angle with respect to the stator;

FIG. 6 is a view showing a magnetic flux distribution with the stator having a groove defined therein near a magnetic flux saturation region for increasing the magnetic resistance of the magnetic flux saturation region;

FIG. 7 is a view showing a magnetic flux distribution with the stator having a hole defined therein near a magnetic flux saturation region for increasing the magnetic resistance of the magnetic flux saturation region;

FIG. 8 is a graph showing torque waveforms before and after a torque ripple is reduced;

FIG. 9 is a fragmentary view of a rotary electric machine free of grooves for reducing a torque ripple;

FIG. 10 is a set of fragmentary views showing variations of the positions of grooves; and

FIG. 11 is a diagram illustrating the variations of the positions of grooves shown in FIGS. 9 and 10.

### DESCRIPTION OF EMBODIMENTS

Embodiments of the present invention will be described below with reference to the drawings.

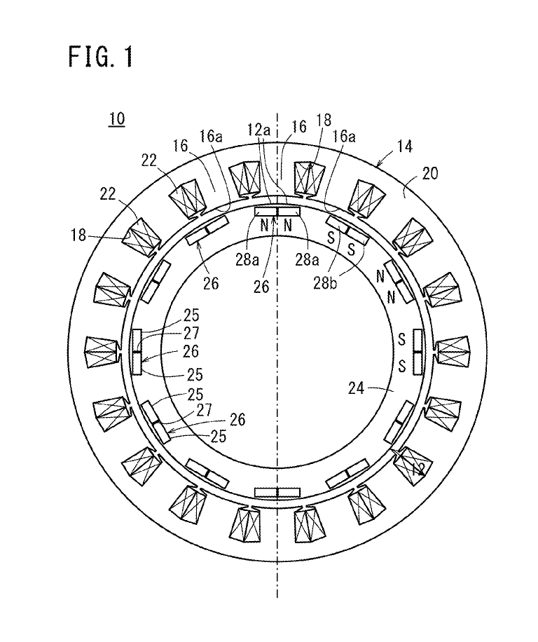

FIG. 1 shows in cross section a rotary electric machine 10 according to an embodiment of the present invention. The rotary electric machine 10 is a rotary electric machine of the IPM type for use as an electric motor for driving (propelling) an EV, for example.

As shown in FIG. 1, the rotary electric machine 10 basically has a rotor 12 integral with a main shaft, not shown, and a stator 14 fixed to a casing, not shown. The rotor 12 is rotatably disposed on the inward side of the stator 14 with an air gap or clearance left therebetween. The rotor 12 is rotatable about the axis of the main shaft, i.e., the shaft of the rotary electric machine 10, which also serves as the axis (axial center) of the rotor 12 and the axis (axial center) of the stator 14. The casing is fixedly mounted on a vehicle frame, not shown.

The rotor 12 has the unillustrated main shaft, a rotor core 24 disposed on an outer circumferential side of the main shaft, and a plurality of (P) permanent magnet assemblies (hereinafter also referred to as “magnetic pole assemblies”) 26 housed and supported in openings 25 defined in the rotor core 24 and extending in the axial direction. The number of rotor poles of the rotor 12 is represented by P (P=12 in the rotary electric machine 10 shown in FIG. 1).

Each of the permanent magnet assemblies 26 includes a pair of axially extending permanent magnets 28a of identical magnetic poles, i.e., magnetized in the same direction, or a pair of axially extending permanent magnets 28b of identical magnetic poles, i.e., magnetized in the same direction. The pairs of the magnets 28a and the pairs of the magnets 28b are alternately arranged in a circumferential array.

The rotor core 24 includes ribs 27 disposed between the permanent magnets 28a, 28a housed in corresponding ones of the openings 25 and between the permanent magnets 28b, 28b housed in corresponding ones of the openings 25, or stated otherwise, disposed circumferentially centrally in the respective magnetic pole assemblies 26. The ribs 27 are thus disposed circumferentially centrally in the respective openings 25.

The stator 14 includes a stator core 20 having a plurality of teeth 16 projecting radially inwardly and a plurality of (S) slots 18 defined therein between the teeth 16, and a plurality of phases (three phases, i.e., U, V, and W phases, in the present embodiment) of coils (armature windings) 22 wound respectively around the teeth 16 and housed in the slots 18 for generating a rotating magnetic field on the side of tip ends 16a of the teeth 16 at cylindrical circumferential surfaces (end faces) of the teeth 16 to rotate the rotor 12. The number of the slots defined in the stator 14 is represented by S (S=18 in the rotary electric machine 10 shown in FIG. 1).

As described above, in the rotary electric machine 10 according to the present embodiment, the number S of the slots 18 is S=18 and the number P of the rotor poles, i.e., the number of the magnetic pole assemblies 26, is P=12.

As described later, the tip ends (end faces) 16a of the teeth 16 of the rotary electric machine 10 which face the rotor 12, and/or an outer circumferential surface (simply referred to as “circumferential surface”) 12a of the rotor 12 which faces the teeth 16 have one or plural grooves defined therein and extending in the axial direction (i.e., in a direction perpendicular to the sheet of FIG. 1), for reducing torque ripples. The grooves function as a magnetic flux saturation (magnetic saturation) promoter, as described later.

A process of determining positions in which to form a magnetic flux saturation promoter in the form of grooves for reducing a torque ripple of the rotary electric machine 10 (the rotor 12) will be described below. Specifically, (A) an explanation of the cause-and-effect relationship between a torque ripple and noise and vibration caused by the torque ripple, (B) a mathematical explanation of a torque ripple component of the rotary electric machine 10, and (C) an explanation of a specific structure and technique for reducing the amplitude of a torque ripple will be described below in the above order.

(A) An Explanation of the Cause-and-effect Relationship Between a Torque Ripple and Noise and Vibration Caused by the Torque Ripple:

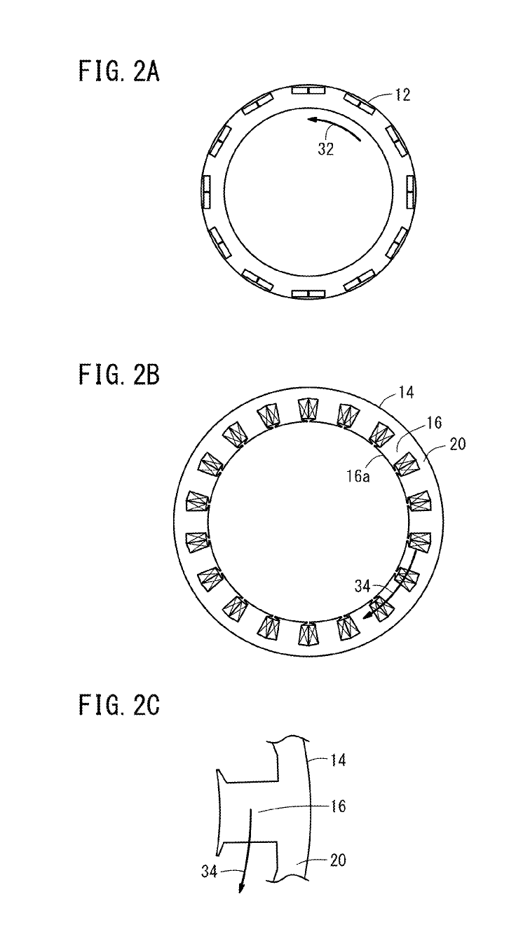

FIG. 2A shows only the rotor 12 of the rotary electric machine 10. When the rotor 12 rotates under the rotating magnetic field generated by the coils 22, as shown in FIG. 2A, a torque is produced on the rotor 12 along a rotational direction indicated by the arrow 32.

FIG. 2B shows only the stator 14 of the rotary electric machine 10. As shown in FIG. 2B, upon rotation of the rotor 12, a torque is produced on the stator 14 along a direction indicated by the arrow 34 which is opposite to the arrow 32, based on the principle of action-reaction.

Since the torque produced on the rotor 12 contains a torque ripple, the torque produced on the stator 14 also contains a torque ripple.

Therefore, as shown FIG. 2B and FIG. 2C, which is an enlarged fragmentary view of the stator shown in FIG. 2B, the torque produced on the stator 14 as indicated by the arrow 34 vibrates the stator core 20 of the stator 14, thereby generating noise and vibration.

In other words, the torque of the rotary electric machine 10, i.e., the torque produced on the stator 14 as indicated by the arrow 34 on account of the torque produced on the rotor 12 based on the principle of action-reaction, vibrates the stator core 20, thereby generating noise and vibration.

Consequently, for reducing noise and vibration that are thus generated, it is only necessary to reduce noise and vibration of the stator 14, or more basically, the torque ripple on the rotor 12 only needs to be reduced.

(B) A Mathematical Explanation of a Torque Ripple Component of the Rotary Electric Machine 10:

Generally, the waveform of a torque T of the rotary electric machine 10 can be expressed by a periodic function according to the following expression (1) where the least common multiple M of the number S of the slots in the stator 14 and the number P of the rotor poles of the rotor 12 is used as a fundamental order:

$$\begin{matrix}T = a 0 + a 1 cos ( M θ + b 1 ) + a 2 cos ( 2 M θ + b 2 ) + a 3 cos ( 3 M θ + b 3 ) + … \\ = a 0 + Σ an cos ( nM θ + bn )\end{matrix} \qquad ( 1 )$$

where E represents the symbol of the sum of terms indicated by n=1, 2, 3, . . . .

In the expression (1), an and bn represent constants and θ represents the rotational angle (mechanical angle) of the rotor 12.

In the first term on the right side of the expression (1), a0 represents an average torque (DC component) which is free of a vibrational component. In the second term on the right side of the expression (1), Σan cos(nMθ+bn) represents a torque ripple component (harmonic component). For reducing the torque ripple of the rotary electric machine 10, therefore, it is necessary to reduce the second term on the right side of the expression (1), i.e., to reduce the amplitude an.

(C) An Explanation of a Specific Structure and Technique for Reducing a Torque Ripple (Amplitude an):

With the rotary electric machine 10 shown in FIG. 1, since the number S of the slots 18 of the stator 14 is S=18 and the number P of the rotor poles of the rotor 12 is P=12, the least common multiple M of the number S and the number P is M=36.

M=36 is substituted in the expression (1), obtaining the expression (2):

$$\begin{matrix}T = a 0 + a 1 cos ( 36 θ + b 1 ) + a 2 cos ( 72 θ + b 2 ) + a 3 cos ( 108 θ + b 3 ) + … \\ = a 0 + Σ an cos ( 36 n θ + bn )\end{matrix} \qquad ( 2 )$$

where Σ represents the symbol of the sum of terms indicated by n=1, 2, 3, . . . .

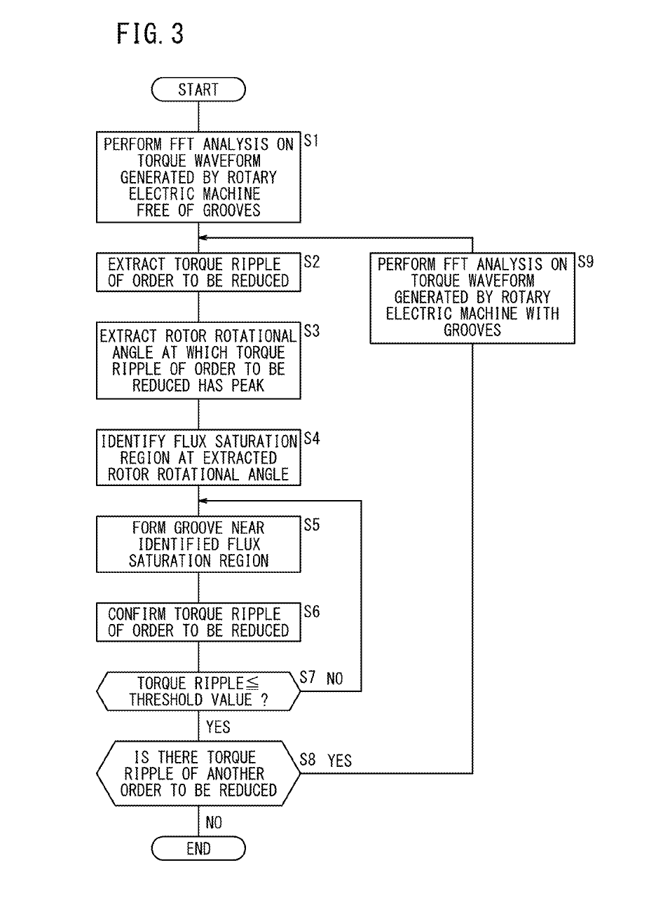

A process (designing process) of determining positions in which to form the grooves for reducing a torque ripple will be described below with reference to FIG. 3 which is a diagram showing a groove forming position determining sequence.

In step S1 (first step), the rotary electric machine 10 with the stator 14 and/or the rotor 12 which do not have grooves defined therein, i.e., with the groove-free state, is energized to rotate at a desired rotational speed, e.g., a rotational speed in normal use, a rated rotational speed, or a rotational speed for a greatest torque ripple, and an FFT (Fast Fourier Transform) analysis is performed on the generated torque waveform.

In step S2 (second step), a torque ripple of the order to be reduced is extracted from the torque waveform, i.e., the result of the FFT analysis on the torque waveform with the groove-free state.

In step S3 (third step), a rotational angle of the rotor 12 at which the torque ripple of the order to be reduced appears as a peak is detected from the result of the FFT analysis.

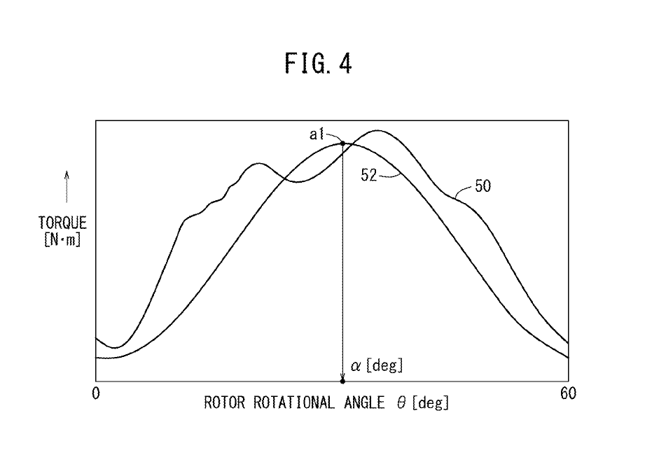

FIG. 4 is a graph showing a torque waveform 50 corresponding to a rotor rotational angle θ [deg] and an nth harmonic torque waveform 52 having a maximum amplitude which is obtained from the torque waveform 50 by way of an FFT analysis. In the present embodiment, the nth harmonic torque waveform with the maximum amplitude is a 136th harmonic torque waveform 52. In other words, the nth harmonic torque waveform with the maximum amplitude is a harmonic torque waveform a1 cos(36θ+b1) representing the fundamental where n×M=1×36 in the expression (2).

In step S3 (third step), therefore, a rotor rotational angle θ=α [deg] where the first (n×M=36) harmonic torque waveform 52 has a peak value α1 as shown in FIG. 4 is extracted as a rotational angle α of the rotor 12 where the torque ripple of the order to be reduced is produced. When a magnetic pole assembly 26 with its N poles facing radially inwardly has a circumferentially central position aligned with the circumferentially central position of a corresponding tooth 16 as indicated by the dot-and-dash line in FIG. 1, the rotor rotational angle θ is defined as θ=0 [deg].

In FIG. 4, the rotor rotational angle θ is θ=0 [deg] at the left end of the horizontal axis and θ=60 [deg] at the right end of the horizontal axis. Since the number P of the rotor poles where the coils 22 in the three phases U, V, W are housed is P=18 in the rotary electric machine 10, it will be understood that the mechanical angle between minimum torque positions is represented as 60 [deg]=360 [deg]÷ (18÷ 3).

In step S4 (fourth step), a simulation is performed on a digital model that is virtually generated using a CAD (Computer-Aided Design) according to CAE (Computer-Aided Engineering), thereby identifying a magnetic flux saturation region (more precisely, a region where near-saturated magnetic fluxes are concentrated) at the position of the rotational angle α of the rotor 12 where the torque ripple of the order to be reduced appears.

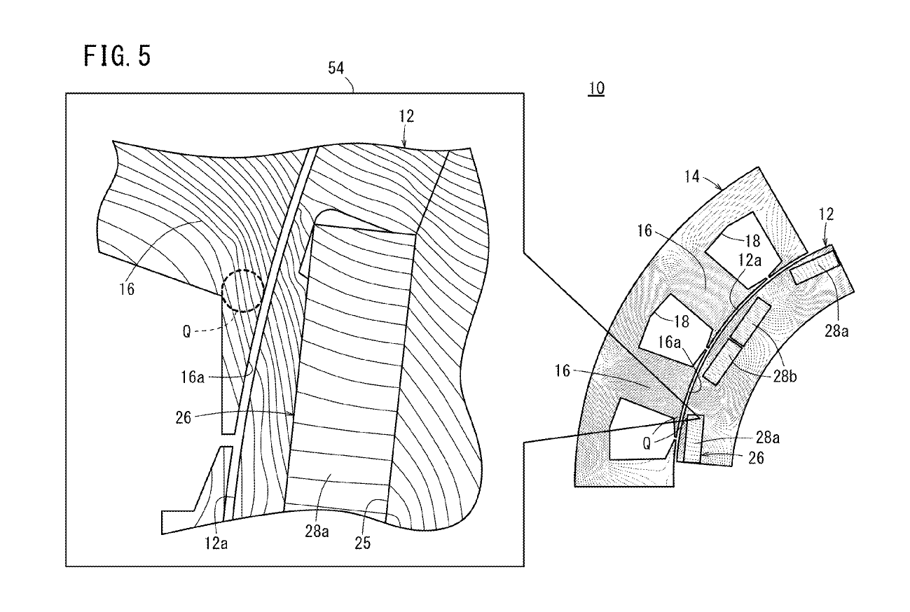

FIG. 5 shows a magnetic flux distribution at a position where the rotor 12 has rotated through the rotational angle α (predetermined rotational angle) with respect to the stator 14.

In FIG. 5, a rectangular area 54 shows at an enlarged scale a portion of the rotor 12 and the stator 14 including a magnetic flux saturation region Q where magnetic fluxes are concentrated in the rotor 12 and the stator 14. In FIG. 5, the magnetic flux saturation region Q, which is represented by a region surrounded by a substantially circular broken line, is positioned in the vicinity of a circumferentially left end of the tip end (end face) 16a of one of the teeth 16 of the stator 14.

The magnetic flux saturation region Q thus positioned is identified in step S4 (fourth step).

The magnetic flux saturation region Q occurs at the rotational angle α of the rotor 12 where the torque ripple of the order to be reduced is produced. In order to reduce the torque ripple of the order to be reduced, it is presumed that it is only necessary to provide the magnetic flux saturation region Q with a structure for promoting the magnetic flux saturation, i.e., a structure with an increased magnetic resistance.

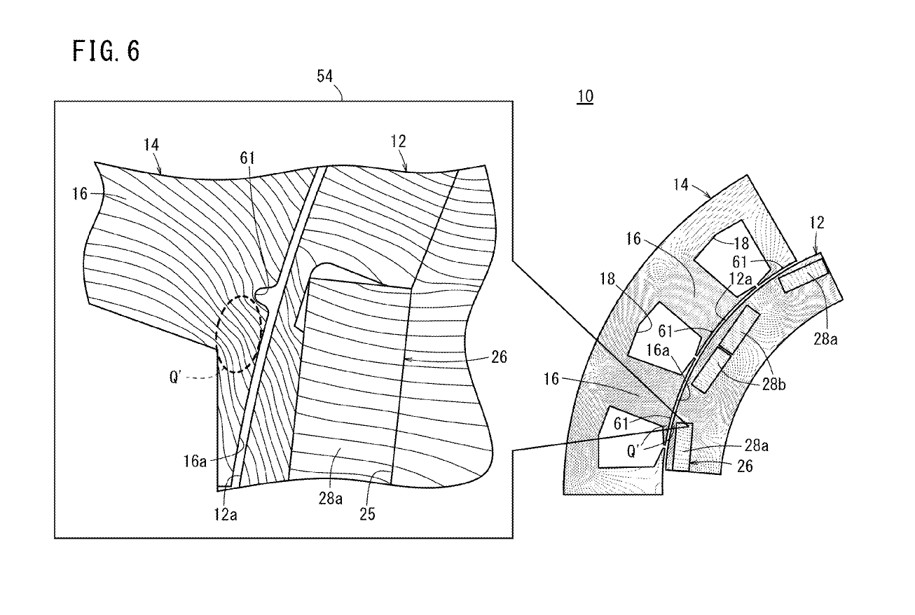

Therefore, in step S5 (fifth step), as shown in FIG. 6, for example, a groove 61 is formed in the tooth 16 near the magnetic flux saturation region Q shown in FIG. 5, or more specifically, near a circumferentially left region of the tip end (end face) 16a of the tooth 16 of the stator 14, the groove 61 extending parallel to the axis of the stator 14 on the CAE. Owing thereto, it is recognized that magnetic fluxes are further concentrated so as to increase magnetic resistance, as shown in a magnetic flux saturation region Q′, which is surrounded by a substantially elliptical broken line in FIG. 6, wider than the magnetic flux saturation region Q surrounded by the substantially circular broken line. Stated otherwise, the groove 61 is effective to enlarge the magnetic flux saturation region Q shown in FIG. 5 into the magnetic flux saturation region Q′ shown in FIG. 6. As described later, the groove 61 may not be formed in the tip end (end face) 16a of the tooth 16 of the stator 14, but may be formed in the circumferential surface 12a of the rotor 12 which faces the groove 61 in the vicinity of the magnetic flux saturation region Q in FIG. 6, or may be formed in both the tip end (end face) 16a and the circumferential surface 12a.

In step S6 (sixth step), it is confirmed whether the torque ripple of the order to be reduced has been reduce or not. Specifically, the stator 14 free of grooves is replaced with a stator 14 with grooves 61 formed therein, and the rotor 12 of the rotary electric machine 10 is rotated at the desired rotational speed referred to above in step S1 (first step). Then, an FFT analysis is carried out on the generated torque waveform, and the torque ripple of the order to be reduced is extracted from the result of the FFT analysis in the same manner as with step S2 (second step).

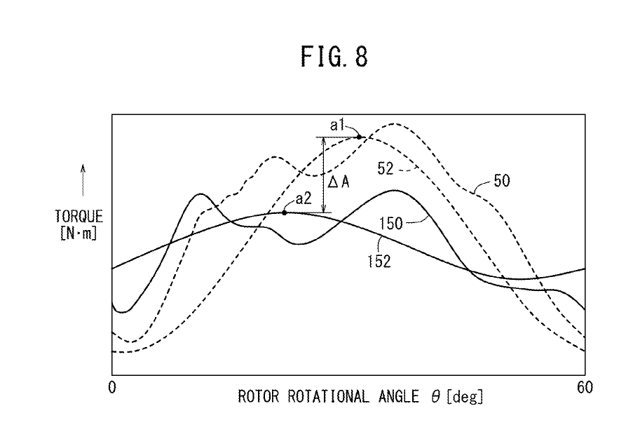

FIG. 8 is a graph showing torque waveforms before and after the torque ripple is reduced. In FIG. 8, the torque waveform 50 indicated by the broken line and the nth harmonic torque waveform (in FIG. 8, the first harmonic torque waveform) 52 indicated by the broken line are waveforms (identical to those shown in FIG. 4) generated by the rotary electric machine 10 that is free of grooves 61 (magnetic flux saturation promoter), and a torque waveform 150 indicated by the solid line and an nth harmonic torque waveform (in FIG. 8, the first harmonic torque waveform) 152 indicated by the solid line are waveforms generated by the rotary electric machine 10 that has grooves 61 formed in the tip ends (end faces) 16a of the teeth 16 of the stator 14, as shown in FIG. 6. It can be seen from FIG. 8 that the peak value a2 of the nth harmonic torque waveform 152 is significantly reduced by an amplitude reduction AA in comparison with the peak value a1 of the nth harmonic torque waveform 52 without the grooves.

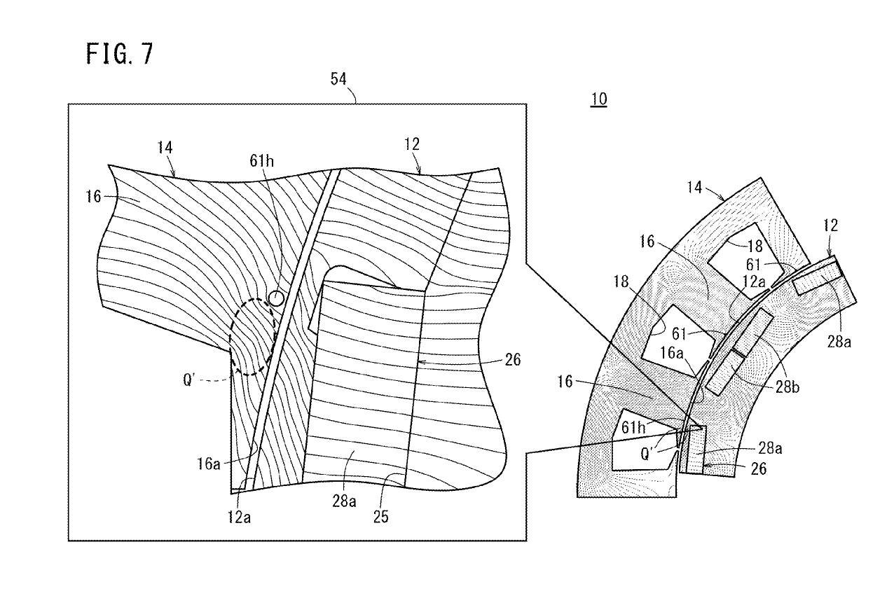

The grooves 61 extend along the axis of the rotary electric machine 10, i.e., along the axis of the stator 14 in FIG. 6. It has been confirmed that as the grooves 61 are wider and deeper, the peak value of the nth harmonic torque waveform is reduced by a greater amount. The groove 61, which functions as the magnetic flux saturation promoter, serves to increase the magnetic resistance of the magnetic flux saturation region Q. However, the magnetic flux saturation promoter is not limited to the groove 61. Therefore, as shown in FIG. 7, for example, the magnetic flux saturation promoter may be in the form of a hole (circular hole or rectangular hole) 61h, which is formed in the stator 14 at a position radially outward of the groove 61 and extends in parallel to the axis of the stator 14, in place of the groove 61 or in addition to the groove 61.

In step S7 (seventh step), it is judged whether or not the amplitude of the torque ripple of the order to be reduced is equal to or smaller than a threshold value serving as a target value. If the amplitude of the torque ripple of the order to be reduced is not equal to or smaller than the threshold value (step S7: NO), then the processing loop from step S5 (fifth step) is repeated until the amplitude of the torque ripple of the order to be reduced becomes equal to or smaller than the threshold value (step S7: YES).

In step S8, it is judged whether there is a torque ripple of another order to be reduced or not, e.g., whether there is a torque ripple represented by a second (n×M=72) harmonic torque waveform, etc. or not. If there is a torque ripple of another order to be reduced (step S8: YES), then in step S9 (ninth step), the rotary electric machine 10 with the stator 14 and/or the rotor 12 which has grooves formed therein, i.e., the grooved stator 14 and/or the grooved rotor 12, is energized to rotate at a desired rotational speed, and an FFT analysis is performed on the generated torque waveform, in the same manner as with step S1. Then, the processing loop from step S2 to step S9 is repeated until the answer to step S8 becomes negative (step S8: NO).

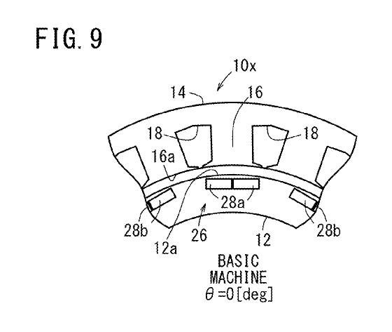

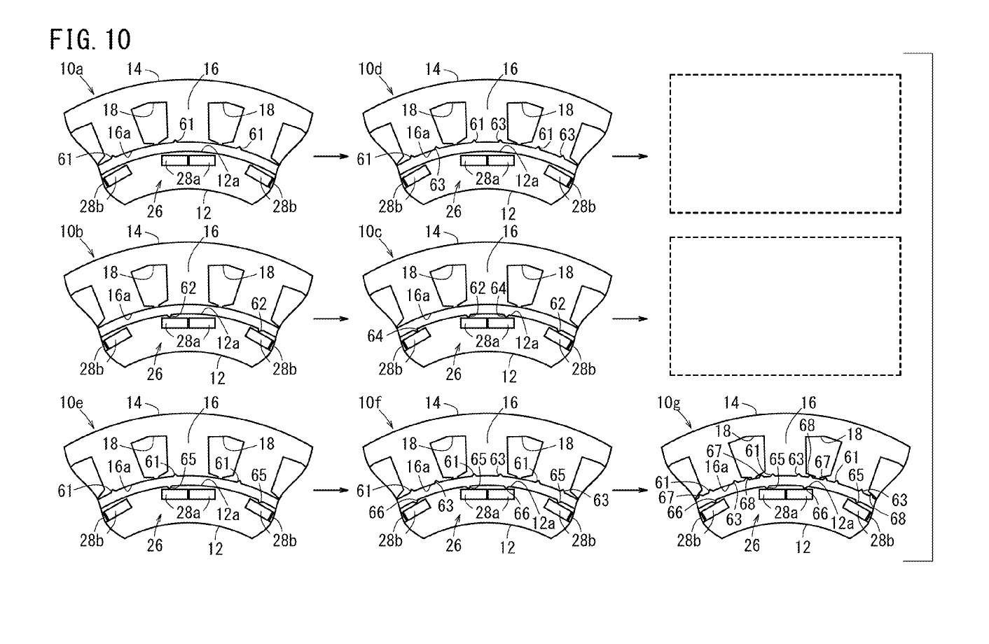

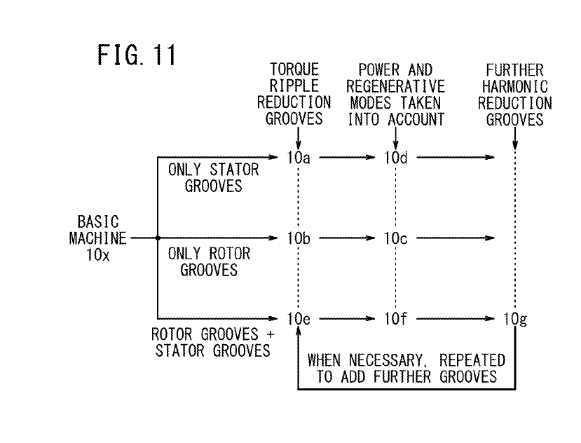

FIG. 9 fragmentarily shows a rotary electric machine 10x free of grooves, which serves as a basic rotary electric machine, FIG. 10 fragmentary shows variations of the positions of grooves, and FIG. 11 illustrates the variations of the positions of grooves shown in FIGS. 9 and 10. Further embodiments of the present invention will be described below with reference to FIGS. 9 through 11.

As shown in FIG. 1, the rotary electric machine 10 according to the embodiment described above includes the stator 14 having S number of the slots 18 formed circumferentially therein, the teeth 16 each disposed between adjacent ones of the slots 18, and the coils 22 wound around the teeth 16, and the rotor 12 disposed on tip ends (end faces) 16a of the teeth 16 of the stator 14 with an air gap or clearance left therebetween and having P number of the magnetic pole assemblies 26 circumferentially disposed respectively in the openings 25 formed in the rotor 12, the openings 25 having the respective ribs 27, the magnetic pole assemblies 26 having respectively the permanent magnets 28a, 28a and the permanent magnets 28b, 28b, wherein at least one of the stator 14 and the rotor 12 has the magnetic flux saturation promoter (the groove 61 or hole, or the like) for promoting the saturation of magnetic fluxes in the magnetic flux saturation region Q, i.e., a region where magnetic flux saturation occurs, in the stator 14 and the rotor 12, the magnetic flux saturation promoter being positioned near the magnetic flux saturation region Q at a rotor phase position (rotor rotational angle α) in which the torque of an nth (n=1, 2, . . . ) harmonic component of a fundamental wave represented by a least common multiple M of the number S of the slots 18 and the number P of the rotor poles of the rotor 12 is maximum.

In FIG. 9, the rotary electric machine 10x, which serves as a basic rotary electric machine, is free of grooves. A rotary electric machine 10a (see FIGS. 10 and 11) has the above-described grooves 61 (also see FIG. 6) defined only in the stator 14 and extending along the axis of the stator 14.

The rotary electric machine 10a (rotary electric machine 10 in the above embodiment) includes the grooves 61 as a magnetic flux saturation promoter in the vicinity of the magnetic flux saturation region Q at the rotor phase position (rotor rotational angle α) in which the torque of the nth harmonic component of the fundamental wave represented by the least common multiple M is maximum. Thus, the magnetic flux saturation promoter is effective to increase the magnetic resistance of the magnetic flux saturation region Q for thereby reducing the torque of the nth harmonic component of the fundamental wave represented by the least common multiple M.

For reducing the inertia and weight of the rotor 12, as shown in FIG. 10 (FIG. 11), a rotary electric machine 10b preferably includes grooves 62, instead of the grooves 61, formed in the circumferential surface 12a (end portion in the radial direction) of the rotor 12 at positions corresponding to the magnetic pole assemblies 26 and extending along the axis of the rotor 12.

In this case, as shown in FIG. 10 (FIG. 11), a rotary electric machine 10c preferably has pairs of grooves 62, 64 (another groove 64) formed at positions corresponding to the magnetic pole assemblies 26 of the rotor 12, wherein each pair of the grooves 62, 64 are arranged symmetrically with respect to the circumferential center of the magnetic pole assembly 26. The symmetrical layout of the pairs of grooves 62, 64 is effective to reduce torque ripples produced when the rotary electric machine 10c operates in a power mode and also in a regenerative mode.

A rotary electric machine 10d shown in FIG. 10 (FIG. 11) may have pairs of grooves 61, 63 (another groove 63) defined in the tip ends (end faces) 16a of the teeth 16 of the stator 14, each pair of the grooves 61, 63 being disposed symmetrically with respect to the circumferential center of the tip end 16a. The symmetrical layout of the pairs of grooves 61, 63 is effective to reduce torque ripples produced when the rotary electric machine 10d operates in power and regenerative modes.

A rotary electric machine 10e shown in FIG. 10 (FIG. 11) may have first grooves, e.g., grooves 61, each defined in at least one of the magnetic pole assembly 26 of the rotor 12 and the stator 14, and second grooves, e.g., grooves 65, defined in at least one of the rotor 12 and the stator 14 in the vicinity of the magnetic flux saturation region Q at a rotor phase position in which the torque of an nth harmonic component produced due to the grooves 61 as the first grooves or an mth harmonic component different from the nth harmonic component is maximum. The grooves 65 as the second grooves are provided in the vicinity of the magnetic flux saturation region Q at the above rotor phase position where the torque of the nth harmonic component produced due to the grooves 61 as the first grooves or the mth harmonic component different from the nth harmonic component is maximum, whereby it is possible to reduce the torque of the nth harmonic component produced due to the grooves 61 as the first grooves or the mth harmonic component different from the nth harmonic component, by the grooves 65 as the second grooves.

In this case also, in view of the power and regenerative modes, a rotary electric machine 10f shown in FIG. 10 (FIG. 11) preferably has symmetrical pairs of groove 65, 66 defined in the rotor 12 and symmetrical pairs of groove 61, 63 defined in the stator 14.

A rotary electric machine 10g shown in FIG. 10 (FIG. 11) may have symmetrical pairs of groove 65, 66 defined in the rotor 12, symmetrical pairs of groove 61, 63 defined in the stator 14, and symmetrical pairs of groove 67, 68 defined in the stator 14 for reducing a torque ripple of a further harmonic.

According to the above embodiments, the order of a harmonic component that provides cause of a torque ripple is identified, and a magnetic flux saturation region Q is identified. The magnetic resistance of the identified magnetic flux saturation region Q is further increased by forming a torque ripple reduction groove. Consequently, the maximum torque of the harmonic of the order that produces the torque ripple can thus be reduced systematically and efficiently.

The present invention is not limited to the above embodiments, but may employ various arrangements based on the disclosure of the description.

1. A rotary electric machine comprising:
a stator having S number of slots formed circumferentially therein, teeth each disposed between adjacent ones of the slots, and coils wound around the teeth; and
a rotor disposed on tip ends of the teeth of the stator with an air gap left between the rotor and the tip ends and having P number of magnetic pole assemblies disposed respectively in openings defined in the rotor, the magnetic pole assemblies being circumferentially arranged and having permanent magnets;
wherein at least one of the stator and the rotor has a magnetic flux saturation promoter for promoting saturation of magnetic fluxes in a region where magnetic flux saturation occurs in the stator and the rotor, the magnetic flux saturation promoter being positioned near the region where the magnetic flux saturation occurs, at a rotor phase position in which a torque of an nth harmonic component of a fundamental wave represented by a least common multiple M of the number S of the slots and the number P of rotor poles of the rotor is maximum.

2. The rotary electric machine according to claim 1, wherein the magnetic flux saturation promoter comprises a groove or a hole defined in each of the tip ends of the teeth of the stator and extending in an axial direction of the stator.

3. The rotary electric machine according to claim 1, wherein the magnetic flux saturation promoter comprises a groove or a hole defined in the rotor radially outwardly of each of the magnetic pole assemblies and extending in an axial direction of the rotor.

4. The rotary electric machine according to claim 2, wherein, the magnetic flux saturation promoter comprises the groove or the hole defined in each of the tip ends of the teeth of the stator and extending in the axial direction of the stator, and another groove or another hole defined in each of the tip ends of the teeth of the stator and extending in the axial direction of the stator, the groove or the hole and the other groove or the other hole being disposed symmetrically with respect to the circumferential center of each of the tip ends of the teeth.

5. The rotary electric machine according to claim 3, wherein, the magnetic flux saturation promoter comprises the groove or the hole defined in the rotor radially outwardly of each of the magnetic pole assemblies and extending in the axial direction of the rotor, and another groove or another hole defined in the rotor radially outwardly of each of the magnetic pole assemblies and extending in the axial direction of the rotor, the groove or the hole and the other groove or the other hole being disposed symmetrically with respect to the circumferential center of each of the magnetic pole assemblies in the rotor.

6. The rotary electric machine according to claim 1, wherein the magnetic flux saturation promoter comprises a first groove or a first hole defined in at least one of the rotor radially outwardly of each of the magnetic pole assemblies, and each of the tip ends of the teeth and extending in an axial direction of the rotary electric machine, and a second groove or a second hole defined in at least one of the stator and the rotor near a region where magnetic flux saturation occurs, at a rotor phase position in which a torque of an nth harmonic component produced due to the first groove or the first hole or an mth harmonic component different from the nth harmonic component is maximum.

7. The rotary electric machine according to claim 6, wherein the first groove or the first hole is defined in the rotor radially outwardly of each of the magnetic pole assemblies, and the second groove or the second hole is defined in at least one of the rotor radially outwardly of each of the magnetic pole assemblies, and each of the tip ends of the teeth.
